(19) United States
(12) Patent Application Publication
(10) Pub. No.: US 2006/0082304 A1
(43) Pub. Date: Apr. 20, 2006

(54) Plasma display panel for reducing noise

(75) Inventor: Jung-Suk Song, Suwon-si (KR)

Correspondence Address: MCGUIREWOODS, LLP, 1750 TYSONS BLVD, SUITE 1800, MCLEAN, VA, 22102, US

(73) Assignee: Samsung SDI Co., Ltd.

(21) Appl. No.: 11/251,889

(22) Filed: Oct. 18, 2005

(30) Foreign Application Priority Data
Oct. 19, 2004 (KR) 10-2004-0083501

(51) Int. Cl. H01J 17/49

(52) U.S. Cl. 313/582

(57) ABSTRACT

A plasma display panel including first and second substrates facing each other and including an image display area and a non-display area arranged outside of the image display area, a plurality of discharge electrodes arranged in the image display area to generate a discharge in a discharge space between the first substrate and the second substrate, and a barrier rib including main barrier ribs arranged in the image display area and partitioning the discharge space and vertically and horizontally symmetric dummy barrier ribs arranged in the non-display area and coupled with the main barrier ribs.

### CROSS-REFERENCE TO RELATED APPLICATION

This application claims priority to and the benefit of Korean Patent Application No. 10-2004-0083501, filed on Oct. 19, 2004, which is hereby incorporated by reference for all purposes as if fully set forth herein.

### BACKGROUND OF THE INVENTION

1. Field of the Invention

The present invention relates to a plasma display panel (PDP), and more particularly, to barrier ribs of a PDP.

1. Discussion of the Background

Generally, a plasma display panel (PDP) is a flat panel display device that displays images using gas discharge. A discharge gas is injected between two substrates including a plurality of discharge electrodes, and phosphor layers are excited by ultraviolet rays generated by the gas discharge.

FIG. 1 is an exploded perspective view of a conventional PDP 100 disclosed in Korean Patent Laid-open Publication No. 02-76603. Referring to FIG. 1, the PDP 100 includes a rear substrate 101, address electrodes 102 formed on the rear substrate 101, a first dielectric layer 103 covering the address electrodes, and main barrier ribs 104 formed on the first dielectric layer 103.

An end of at least one main barrier rib 104 is coupled to an end of an adjacent main barrier rib 104 by a supporting barrier rib 105. The supporting barrier rib 105 may be lower than the main barrier ribs 104 so that discharge gas may be more smoothly exhausted from a sealed space. Red (R), green (G), and blue (B) phosphor layers 106 are formed in discharge spaces partitioned by the main barrier ribs 104 and the supporting barrier rib 105.

The rear substrate 101 is coupled to a front substrate 107, thereby forming the sealed space. Pairs of first and second discharge electrodes 108 and 109 are formed on the front substrate 107 in a direction substantially orthogonal to the address electrodes 102. The first and second discharge electrodes 108 and 109 include bus electrodes 110. A black matrix layer 111 is interposed between pairs of the first and second discharge electrodes 108 and 109. A second dielectric layer 112 covers the first and second discharge electrodes 108 and 109 and the black matrix layer 111, and a protective layer 113 covers the second dielectric layer 112.

In the conventional PDP 100, since the main barrier ribs 104 are coupled to the supporting barrier rib 105, it may be possible to prevent ends of the main barrier ribs 104 from breaking during manufacturing. Additionally, since discharge spaces are defined by the supporting barrier rib 105, pixel cross-talk may be prevented.

A barrier rib may be fabricated using sand blast, press, or photosensitive methods. After forming a desired pattern, the barrier rib is baked at about 450° C. or higher to burn impurities in the barrier rib's raw material and unnecessary binders, as well as to further solidify the barrier rib.

As the binders burn away, the barrier rib contracts. In the case of the PDP 100, the contracting main barrier ribs 104 tend to transform into an “S” shape, bending toward a display area, whereas the supporting barrier rib 105 is fixed to its position. Hence, a portion of the contracted main barrier ribs 104 has a depressed shape.

As a result, when stresses between the rear substrate 101 and the front substrate 107 reduce due to increased pressure, the PDP 100 vibrates more, which produces more noise.

To prevent such a transformation in the barrier rib, referring to FIG. 2 and FIG. 3, a dummy barrier rib 200 may be formed at an edge of the main barrier ribs. The dummy barrier rib 200 includes straight-line portions 201, including discontinuous straight lines, and ark-shaped portions 202, which are formed along ends of the straight-line portions 201.

The dummy barrier rib 200 may prevent the barrier rib from being depressed due to the contraction during baking. However, upper ends of some of the ark-shape portions 202 may slant when the barrier rib contracts. A gap g in the slanted upper end of the ark-shaped portion 202 may be approximately 12 through 15 micrometers. Accordingly, a gap is created between the front substrate and the barrier rib, which causes a PDP assembly to vibrate, thereby producing noise.

### SUMMARY OF THE INVENTION

The present invention provides a plasma display panel (PDP) in which ends of barrier ribs are vertically and horizontally symmetrical such that symmetric forces of the barrier ribs prevent the barrier ribs from bending or slanting.

Additional features of the invention will be set forth in the description which follows, and in part will be apparent from the description, or may be learned by practice of the invention.

The present invention discloses a PDP including a first substrate and a second substrate facing each other and including an image display area and a non-display area arranged outside of the image display area. A plurality of discharge electrodes are arranged in the image display area to generate a discharge in a discharge space between the first substrate and the second substrate. A barrier rib includes main barrier ribs arranged in the image display area to partition the discharge space and vertically and horizontally symmetric dummy barrier ribs are arranged in the non-display area and coupled with the main barrier ribs.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view of a conventional plasma display panel PDP.

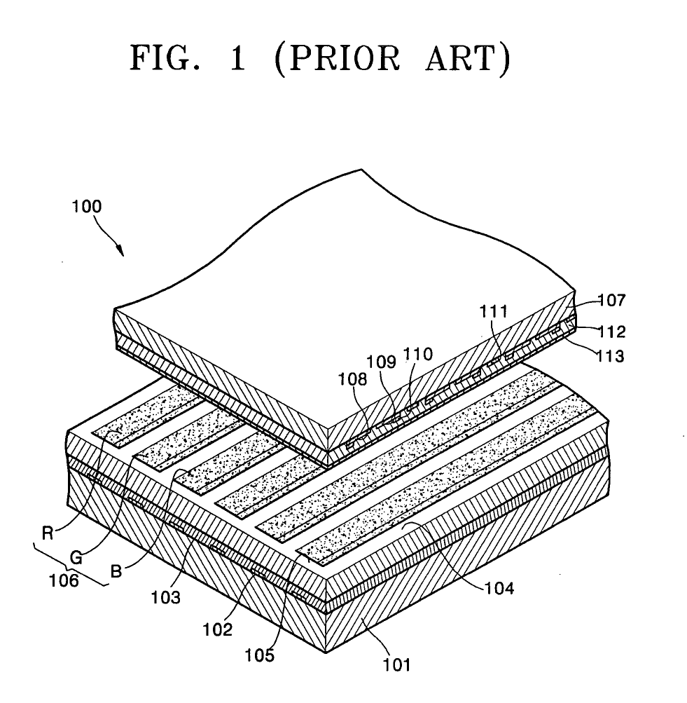

FIG. 2 is a plan view of a conventional dummy barrier rib.

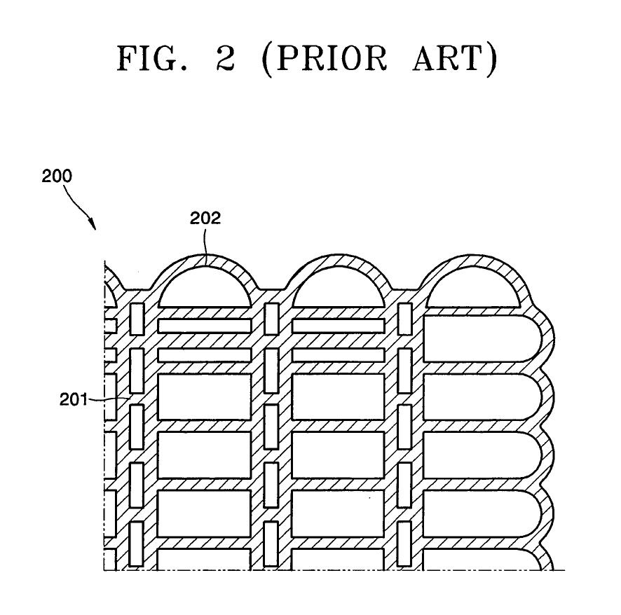

FIG. 3 is a perspective view of the dummy barrier rib of FIG. 2.

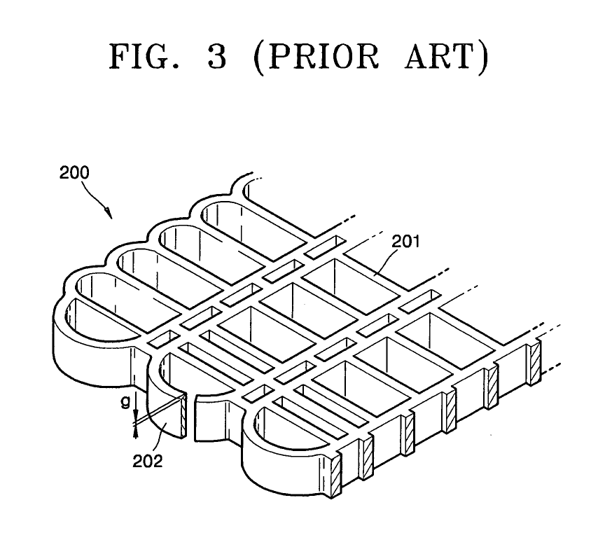

FIG. 4 is an exploded perspective view of a PDP according to an exemplary embodiment of the present invention.

FIG. 5 is an enlarged plan view of barrier ribs of the PDP of FIG. 4.

FIG. 6 is a perspective view of a dummy barrier according to a first exemplary embodiment of the present invention.

FIG. 7 is a perspective view of a dummy barrier according to a second exemplary embodiment of the present invention.

FIG. 8 is a perspective view of a dummy barrier according to a third exemplary embodiment of the present invention.

FIG. 9 is a perspective view of a dummy barrier according to a fourth exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

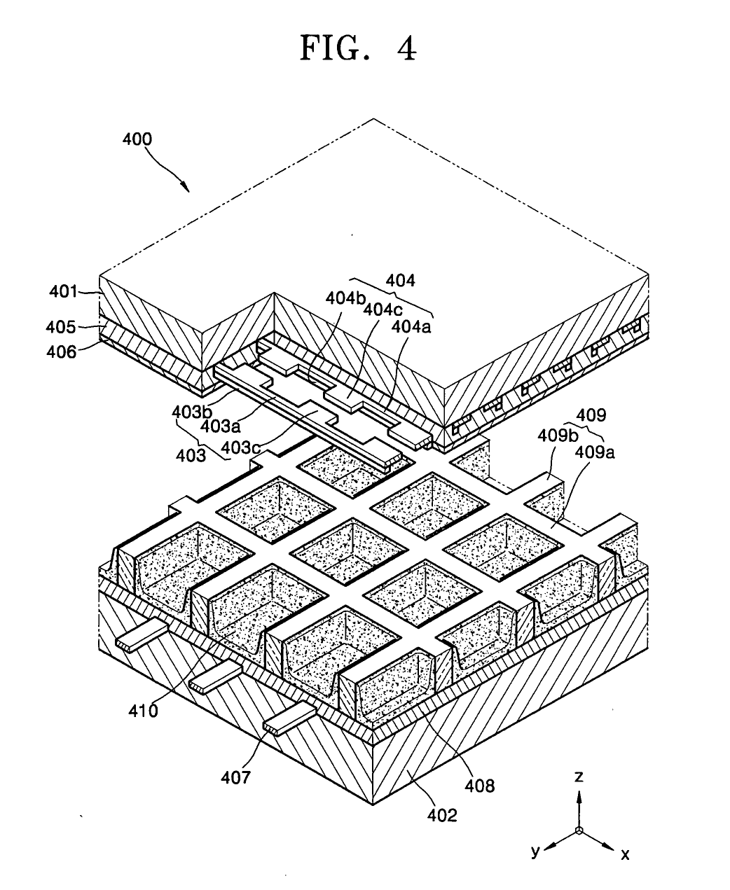

FIG. 4 is an exploded perspective view of a portion of a plasma display panel (PDP) 400 according to an exemplary embodiment of the present invention.

Referring to FIG. 4, the PDP 400 includes a front substrate 401 and a rear substrate 402 arranged substantially parallel to each other. A frit glass may be applied along edges of the front and rear substrates 401 and 402 to couple the substrates together and seal a discharge space.

The front substrate 401 may be formed of a transparent material such as, for example, soda lime glass. X and Y electrodes 403 and 404 extend in an X direction of the PDP 400 and are alternately arranged on a lower surface of the front substrate 401 in a Y direction of the PDP 400. A pair of the X and Y electrodes 403 and 404 is included in each discharge cell.

The X electrode 403 includes a first transparent electrode line 403a and a first bus electrode line 403b coupled with the first transparent electrode line 403a. A plurality of first protrusions 403c protrude from an inner wall of the first transparent electrode line 403a toward the Y electrode 404.

The Y electrode 404 is substantially symmetrical to the X electrode 403, and it includes a second transparent electrode line 404a and a second bus electrode line 404b coupled with the second transparent electrode line 404a. A plurality of second protrusions 404c protrude from an inner wall of the second transparent electrode line 404a toward the X electrode 403.

The first and second transparent electrode lines 403a and 404a are formed of transparent conductive films such as, for example, indium tin oxide (ITO) films, to enhance an aperture rate of the front substrate 401. The first and second bus electrode lines 403b and 404b are formed of highly conductive metallic material such as, for example, Ag paste or a chrome-copper-chrome alloy, to reduce the line resistance of the first and second transparent electrode lines 403a and 404a and improve electrical conductivity.

A space between pairs of the X and Y electrodes 403 and 404 is a non-discharge area, which may include a black striped layer to enhance contrast.

A front dielectric layer 405 covers the X and Y electrodes 403 and 404. The front dielectric layer 405 may be formed of glass paste including various fillers, and it may be selectively printed on a portion of the front substrate 401 where the X and Y electrodes 403 and 404 are patterned. Alternatively, the front dielectric layer 405 may be printed on the entire lower surface of the front substrate 401, as shown in FIG. 4. A protective layer 406, such as an MgO layer, covers the front dielectric layer 405 to protect the front dielectric layer 405 from damage and increase secondary electron emission.

The rear substrate 402 may be formed of the same material as the front substrate 401. Address electrodes 407 are arranged on the rear substrate 402 in a direction crossing a direction in which the X and Y electrodes 403 and 404 are arranged. A rear dielectric layer 408 covers the address electrodes 407.

A plurality of main barrier ribs 409 are arranged between the front and rear substrates 401 and 402 to partition the discharge space into discharge cells. The main barrier ribs 409 include a plurality of first barrier ribs 409a, which are arranged in a direction crossing a direction in which the address electrodes 407 are arranged, and a plurality of second barrier ribs 409b, which are arranged substantially parallel to the address electrodes 407. Each first main barrier rib 409a is integrated into the second main barrier ribs 409b and extends in a direction crossing a direction in which adjacent pairs of the second main barrier ribs 409b are arranged, and the coupled first and second main barrier ribs 409a and 409b form a matrix pattern.

Alternatively, the main barrier ribs 409 may be formed in, for example, a meander pattern, a delta pattern, or a honeycomb pattern. The discharge cells defined by the main barrier ribs 409 may be formed in various shapes, including other polygonal shapes or in a substantially circular shape.

Additionally, a discharge gas such as Ne-Xe or He-Xe is injected into the discharge cells.

R, G, and B phosphor layers 410, which are excited by ultraviolet rays generated by the discharge gas to emit visible light, are arranged in the discharge cells. The phosphor layers 410 may be coated on any region in the discharge cell. However, in the present embodiment, the phosphor layers 410 are coated on inner surfaces of the main barrier ribs 409 and on the rear dielectric layer 408. The R, G, or B phosphor layer 410 is coated in each discharge cell. For example, the red phosphor layer may be formed of (Y,Gd)BO₃:Eu⁺³, the green phosphor layer may be formed of Zn₂SiO₄:Mn²⁺, and the blue phosphor layer may be formed of BaMgAl₁₀O₁₇:Eu²⁺.

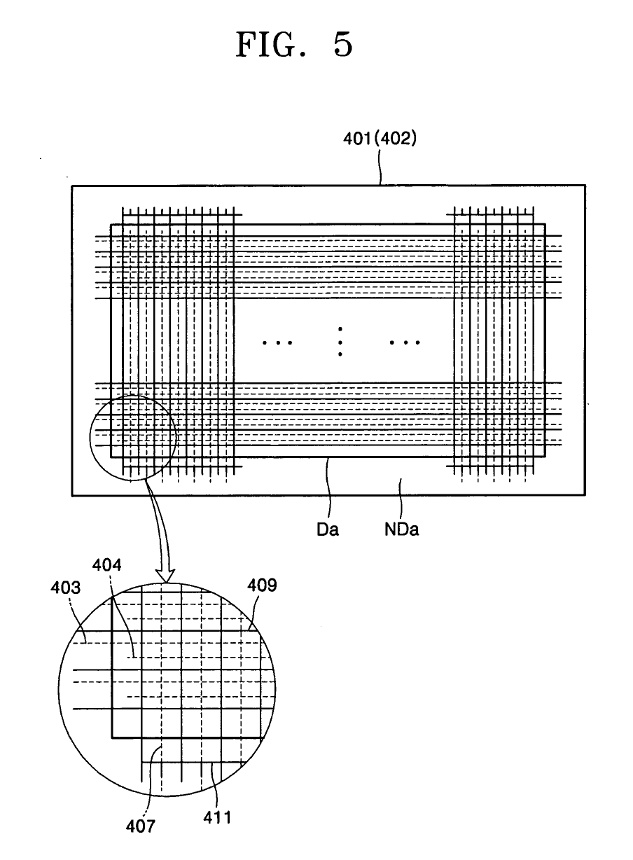

FIG. 5 shows discharge electrodes and barrier ribs arranged on the front and rear substrates 401 and 402 of FIG. 4.

Referring to FIG. 5, the front and rear substrates 401 and 402 include an image display area Da, where an image is displayed, and a non-display area NDa, which is arranged outside the display area Da and includes terminals coupled with driving circuits.

In the display area Da, the X and Y electrodes 403 and 404 are alternately arranged extending along the X direction of the PDP 400, and the address electrodes 407 are arranged extending along the Y direction of the PDP 400. Also, the main barrier ribs 409 are arranged in the display area Da, and a pair of X and Y electrodes 403 and 404 and an address electrode 407 are arranged in each discharge cell defined by the main barrier ribs 409.

Vertically and horizontally symmetric dummy barrier ribs 411 are arranged on outer walls of the main barrier ribs 409 to prevent the main barrier ribs 409 from contracting and bending during baking. The dummy barrier ribs 411 are integrally coupled with the main barrier ribs 409. The structure of the dummy barrier ribs 411 will be described in detail below.

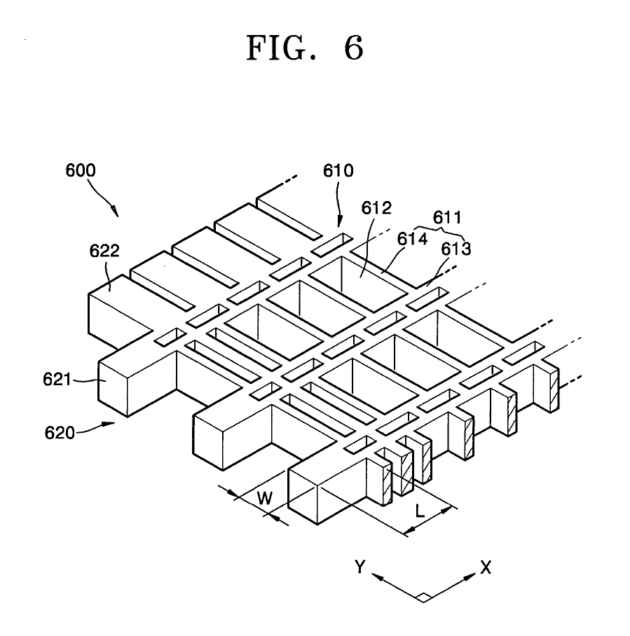

FIG. 6 is a perspective view of a dummy barrier rib 600 according to a first exemplary embodiment of the present invention.

Referring to FIG. 6, the dummy barrier rib 600 includes connection barrier ribs 610, which are coupled with the main barrier ribs 409 of FIG. 4, and reinforcement barrier ribs 620, which are arranged at edges of the connection barrier ribs 610.

The connection barrier ribs 610 include straight-line portions 611 and openings 612 formed between the straight-line portions 611. The straight-line portions 611 include first straight-line portions 613, which are arranged in the X direction of the PDP 400, and second straight-line portions 614, which are arranged in the Y direction of the PDP 400. The first and second straight-line portions 613 and 614 have different widths, cross each other, and are coupled with each other. Additionally, the first and second straight-line portions 613 and 614 may be discontinuously or continuously arranged along the X and Y directions of the PDP 400.

The openings 612 are formed between the first and second straight-line portions 613 and 614, and they may have different sizes. The openings 612 are substantially rectangular shaped through-holes that may be discontinuously or continuously formed to be separated from each other by predetermined intervals.

The reinforcement barrier ribs 620 are integrally coupled with the connection barrier ribs 610. The reinforcement barrier ribs 620 include first reinforcement portions 621, which are coupled with the first straight-line portions 613, and second reinforcement portions 622, which are coupled with the second straight-line portions 614.

The first and second reinforcement portions 621 and 622 have substantially the shape of a rectangular pillar. The first and second reinforcement portions 621 and 622 protrude from edges of the connection barrier ribs 610 and are separated from each other by predetermined intervals along the X and Y directions of the PDP 400. Also, ends of the first and second reinforcement portions 621 and 622 are not connected to each other and they extend integrally from the connection barrier ribs 610.

The reinforcement barrier ribs 620 are vertically and horizontally symmetric to suppress an inward contractile force during baking. In other words, the contractile force works on the reinforcement barrier ribs 620 vertically and horizontally, whereas it works only on a streamlined portion of a conventional ark-shaped barrier rib. Accordingly, it is possible to prevent the reinforcement barrier ribs 620 from bending and to prevent upper ends of the reinforcement barrier ribs 620 from slanting.

The relationship between a length L and a width W of each of the reinforcement barrier ribs 620 may be 2W<L to better suppress the contractile force.

A process for fabricating a barrier rib of the PDP 400 having this structure will now be described with reference to FIG. 4, FIG. 5 and FIG. 6.

The address electrodes 407 are patterned on the rear substrate 402 and covered by the rear dielectric layer 408. Then, a material for forming a barrier rib is applied on the rear dielectric layer 408.

After coating a photoresist layer on the barrier rib forming material, photomasks are arranged on an upper portion of the photoresist layer to be exposed and developed.

Through an etching process, unnecessary portions of the barrier rib forming material are removed, thereby forming a shape of the main barrier ribs 409. Here, since the photoresist layer still remains on upper surfaces of the main barrier ribs 409, it is subsequently removed to complete the main barrier ribs 409. The patterned main barrier ribs 409 are heated at about 450° C. or higher to burn impurities contained in the barrier rib forming material and binders.

The dummy barrier ribs 600 may be simultaneously patterned with the main barrier ribs 409.

To maintain their shape against the contractile force that might otherwise bend or transform the barrier rib during baking, the dummy barrier ribs 600 include the connection barrier ribs 610 and the reinforcement barrier ribs 620 protruding from the connection barrier ribs 610.

Since the reinforcement barrier ribs 620 are supported by the straight-line portions 611 of the connection barrier ribs 610 arranged inside the reinforcement barrier ribs 620, the reinforcement barrier ribs 620 do not bend. Each straight-line portion 611 receives a parallel force from other surrounding straight-line portions 611.

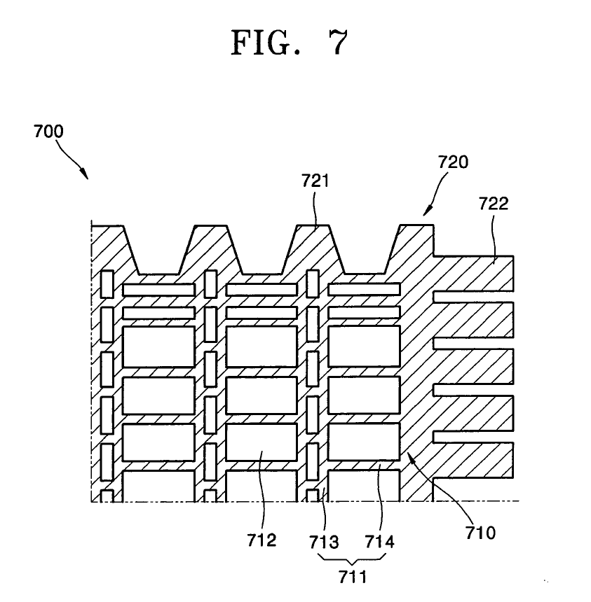

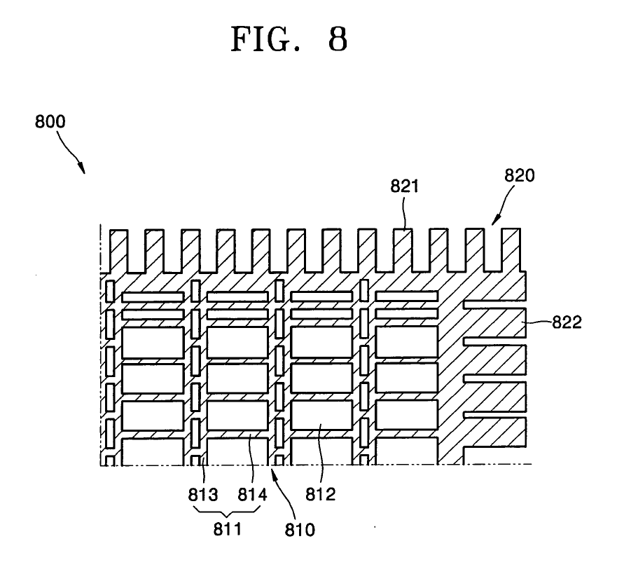

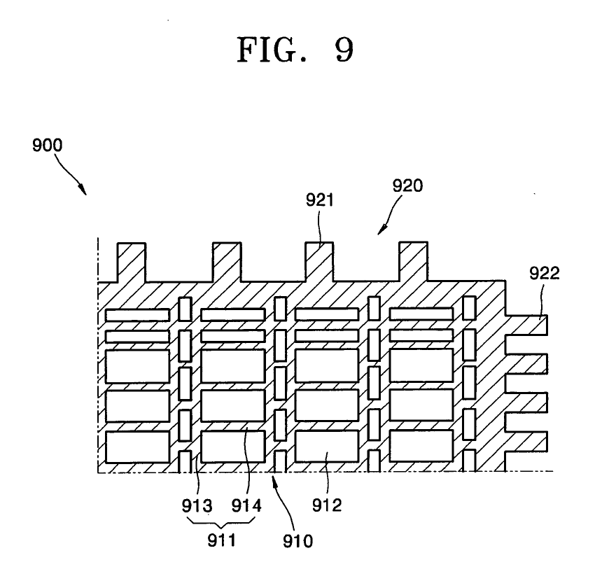

FIG. 7, FIG. 8, and FIG. 9 are perspective views of dummy barrier ribs 700, 800, and 900, respectively, according to other exemplary embodiments of the present invention. Only the features of the dummy barrier ribs 700, 800, and 900 will be described below.

Referring to FIG. 7, the dummy barrier rib 700 includes connection barrier ribs 710 and reinforcement barrier ribs 720 arranged along edges of the connection barrier ribs 710.

The connection barrier ribs 710 include straight-line portions 711 and openings 712 formed between the straight-line portions 711. The straight-line portions 711 include first straight-line portions 713 and second straight-line portions 714. The second straight-line portions 714 are arranged in a direction crossing a direction in which the first straight-line portions 713 are arranged. The first and second straight-line portions 713 and 714 form an assembly of discontinuous or continuous straight lines.

Additionally, the reinforcement barrier ribs 720 are arranged along the edges of the connection barrier ribs 710 and include first reinforcement portions 721, which are coupled with the first straight-line portions 713, and second reinforcement portions 722, which are coupled with the second straight-line portions 714. The cross-section of the first reinforcement portions 721 is substantially trapezoidal, and that of the second reinforcement portions 722 is substantially rectangular.

Referring to FIG. 8, the dummy barrier rib 800 includes connection barrier ribs 810 and reinforcement barrier ribs 820 arranged along edges of the connection barrier ribs 810. The connection barrier ribs 810 include straight-line portions 811 including first and second straight-line portions 813 and 814 that are discontinuously or continuously formed along vertical and horizontal directions of a panel. Openings 812 are formed between the first and second straight-line portions 813 and 814.

The reinforcement barrier ribs 820 include first reinforcement portions 821, which are coupled with the first straight-line portions 813, and second reinforcement portions 822, which are coupled with the second straight-line portions 814. The cross-section of the first and second reinforcement portions 821 and 822 is substantially rectangular. The first and second reinforcement portions 821 and 822 are not separated by the same interval. That is, the first reinforcement portions 821 are separated from each other by wider intervals than those separating the second reinforcement portions 822.

Referring to FIG. 9, the dummy barrier rib 900 includes connection barrier ribs 910 and reinforcement barrier ribs 920 coupled with the connection barrier ribs 910. The connection barrier ribs 910 include straight-line portions 911 including first and second straight-line portions 913 and 914 that are discontinuously or continuously formed along vertical and horizontal directions of a panel and openings 912 formed between the first and second straight-line portions 913 and 914.

The reinforcement barrier ribs 920 include first reinforcement portions 921, which are integrally coupled with the first straight-line portions 913, and second reinforcement portions 922, which are integrally coupled with the second straight-line portions 914. The cross-sections of the first and second reinforcement portions 921 and 922 are substantially rectangular. The second reinforcement portions 922 are narrower than the first reinforcement portions 921. Also, the second reinforcement portions 922 are separated from each other by narrower intervals than the first reinforcement portions 921.

As described above, the dummy barrier ribs 700, 800, and 900 of FIG. 7, FIG. 8, and FIG. 9, respectively, are coupled with the main barrier ribs 409 and they may be arranged in various shapes. Since the dummy barrier ribs 700, 800, and 900 are vertically and horizontally symmetric, symmetric forces of the dummy barrier ribs 700, 800, and 900 prevent them from bending and prevent a portion of upper ends of the dummy barrier rib 700, 800, or 900 from slanting during baking.

As described above, a PDP for reducing noise according to exemplary embodiments of the present invention includes a vertically and horizontally symmetric dummy barrier rib arranged along an edge of a substrate, thereby achieving the following effects.

First, the dummy barrier rib is prevented from bending inward due to a contractile force during a baking process. Thus, it is possible to minimize noise generated when driving a PDP assembly.

Second, since a barrier rib may be prevented from slanting or transforming during baking, the barrier rib may be formed where expected and the degree of adherence of the PDP assembly may be significantly enhanced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel (PDP), comprising:
a first substrate and a second substrate facing each other and including an image display area and a non-display area arranged outside of the image display area;
a plurality of discharge electrodes arranged in the image display area to generate a discharge in a discharge space between the first substrate and the second substrate; and
a barrier rib comprising main barrier ribs arranged in the image display area and partitioning the discharge space and dummy barrier ribs arranged in the non-display area and coupled with the main barrier ribs,
wherein the dummy barrier ribs are symmetric vertically and horizontally.

2. The PDP of claim 1, wherein the dummy barrier ribs comprise:
connection barrier ribs integrally coupled with the main barrier ribs, and
reinforcement barrier ribs arranged along edges of the connection barrier ribs.

3. The PDP of claim 2, wherein the connection barrier ribs comprise:
straight line portions comprising first straight line portions and second straight line portions crossing each other, and
openings formed between the first straight line portions and the second straight line portions.

4. The PDP of claim 3, wherein each straight line portion comprises discontinuous or continuous straight lines.

5. The PDP of claim 2, wherein the reinforcement barrier ribs protrude integrally from the edges of the connection barrier ribs.

6. The PDP of claim 5, wherein ends of the reinforcement barrier ribs are separated by predetermined intervals from each other.

7. The PDP of claim 5, wherein the reinforcement barrier ribs comprise a substantially rectangular pillar-like shape.

8. The PDP of claim 5, wherein the reinforcement barrier ribs protrude from the edges of the connection barrier ribs by more than twice a width of the reinforcement barrier ribs.

9. The PDP of claim 1, wherein the dummy barrier ribs comprise connection barrier ribs integrally coupled with the main barrier ribs and reinforcement barrier ribs protruding from edges of the connection barrier ribs, and
wherein the connection barrier ribs are symmetrical to each other.
10. The PDP of claim 9, wherein ends of the reinforcement barrier ribs are separated by predetermined intervals from each other.
11. The PDP of claim 10, wherein the reinforcement barrier ribs are vertically and horizontally symmetric.
